(19) United States
(12) Patent Application Publication
(10) Pub. No.: US 2014/0168549 A1
(43) Pub. Date: Jun. 19, 2014

(54) STEREOSCOPIC DISPLAY DEVICE

(71) Applicants: Takehiro Murao, Osaka-shi (JP); Takuto Yoshino, Osaka-shi (JP); Hiroshi Fukushima, Osaka-shi (JP); Tomoo Takatani, Osaka-shi (JP)

(72) Inventors: Takehiro Murao, Osaka-shi (JP); Takuto Yoshino, Osaka-shi (JP); Hiroshi Fukushima, Osaka-shi (JP); Tomoo Takatani, Osaka-shi (JP)

(73) Assignee: SHARP KABUSHIKI KAISHA, Osaka-shi, Osaka (JP)

(21) Appl. No.: 14/240,189

(22) PCT Filed: Aug. 22, 2012
(86) PCT No.: PCT/JP2012/071149

§ 371 Date: Feb. 21, 2014

(30) Foreign Application Priority Data
Aug. 31, 2011 (JP) 2011-189042

(51) Int. Cl. G02B 27/22

(52) U.S. Cl. CPC G02B 27/2214
USPC 349/15

(57) ABSTRACT

Provided is a vertically and horizontally positionable stereoscopic display device that is capable of, while preventing the crosstalk ratio from deteriorating, increasing the brightness during 3D display, switching 2D display and 3D display without decreases in the resolution during 2D display, and achieving a switching response speed at the same level as that in the parallax barrier method. A switching liquid crystal panel (14) realizes a parallax barrier (48) in which transmission parts (52) and light shielding parts (50) are arrayed alternately. The switching liquid crystal panel includes a pair of substrates (30, 32). On the substrates, drive electrodes (36, 42) and auxiliary electrodes (38, 44) are arranged alternately. When the switching liquid crystal panel is viewed from the front, the drive electrodes and the auxiliary electrodes formed on one of the substrates are orthogonal to the drive electrodes and the auxiliary electrodes formed on the other substrate. The transmission parts have an opening width that is equal to or greater than an opening width of the pixels (28) in a direction in which the transmission parts and the light shielding parts are arrayed alternately

### TECHNICAL FIELD

The present invention relates to a stereoscopic display device including a switching liquid crystal panel.

### BACKGROUND ART

As a method for allowing a viewer to view stereoscopic images without using special glasses, the parallax barrier method and the lenticular lens method have been known since before. For example, JP2004-264760A (Patent Document 1) discloses a stereoscopic video display device that includes a switching liquid crystal panel that is capable of realizing a parallax barrier in which openings for transmitting light and light shielding parts for blocking light are arrayed alternately. In the parallax barrier method, however, though it is possible to switch 2D display and 3D display from one to the other without a decrease in the resolution during 2D display, brightness during 3D display is 50% or less as compared with that during 2D display, due to light blocking with light shielding parts for the left-right image separation necessary for stereoscopic display.

On the other hand, in the lenticular lens method, since a lens sheet is attached over a display panel so that images are separated by the light condensing effect of the lenses, the brightness during 3D display at the same level or higher as compared with that during 2D display can be ensured. During 2D display, however, the resolution in the horizontal direction becomes ½ or less (the resolution becomes 1/N where N represents the number of viewing points), since the light condensing effect is exhibited during 2D display as well.

In this way, both of the parallax barrier method and the lenticular lens method have advantages and disadvantages. As a method that attempts to improve these disadvantages, the liquid crystal lens method is available. For example, JP2004-258631A (Patent Document 2) and JP2009-520231T (Patent Document 3) disclose a stereoscopic display device in which a voltage is applied across a pair of substrates so that pseudo lenses are formed in a liquid crystal layer sealed between these substrates in pair. In the stereoscopic display device disclosed in Patent Documents 2 and 3, however, a desired lens effect could hardly be exhibited at boundary areas between adjacent two of the lenses, which causes the crosstalk ratio to deteriorate. Besides, since the image separation is performed only by light condensing by the liquid crystal lenses, the liquid crystal layer has to have a greater thickness in order to achieve a satisfactory light condensing effect, which causes a problem that the switching speed for the switching between 2D display and 3D display decreases. In addition to this, it is significantly difficult to keep the cell thickness uniform, which causes a problem of poor mass producibility.

### DISCLOSURE OF INVENTION

It is an object of the present invention to provide a vertically and horizontally positionable stereoscopic display device that is capable of, while preventing the crosstalk ratio from deteriorating, increasing the brightness during 3D display, switching 2D display and 3D display without decreases in the resolution during 2D display, and achieving a switching response speed at the same level as that in the parallax barrier method.

A stereoscopic display device of the present invention includes: a display panel that has a plurality of pixels, and displays a synthetic image in which a right eye image and a left eye image that are divided in a stripe form are arrayed alternately; and a switching liquid crystal panel that is arranged on one side in the thickness direction of the display panel and is capable of realizing a parallax barrier in which transmission parts that transmit light and light shielding parts that block light are arranged alternately, wherein the switching liquid crystal panel includes: a pair of substrates; a liquid crystal layer sealed between the substrates in pair; a plurality of drive electrodes formed on each of the substrates in pair; and a plurality of auxiliary electrodes formed on each of the substrates in pair, the auxiliary electrodes and the drive electrodes being arranged alternately. In the stereoscopic display device, the drive electrodes and the auxiliary electrodes formed on one of the substrates in pair are orthogonal to the drive electrodes and the auxiliary electrodes formed on the other substrate when viewed from the front of the switching liquid crystal panel; a voltage different from a voltage applied to the drive electrodes and the auxiliary electrodes formed on the one substrate is applied to the drive electrodes formed on the other substrate, whereby the light shielding parts are formed; and the transmission parts have an opening width that is equal to or greater than an opening width of the pixels in a direction in which the transmission parts and the light shielding parts are arrayed alternately.

The vertically and horizontally positionable stereoscopic display device of the present invention is capable of, while preventing the crosstalk ratio from deteriorating, increasing the brightness during 3D display, switching 2D display and 3D display without decreases in the resolution during 2D display, and achieving a switching response speed at the same level as that in the parallax barrier method.

### BRIEF DESCRIPTION OF DRAWINGS

FIG. 1 schematically shows an exemplary schematic configuration of a stereoscopic display device as an embodiment of the present invention.

FIG. 2 is a cross-sectional view showing an exemplary schematic configuration of a switching liquid crystal panel provided in the stereoscopic display device shown in FIG. 1, which is a cross-sectional view taken along a line II-II in FIG. 3.

FIG. 3 is a cross-sectional view showing an exemplary schematic configuration of a switching liquid crystal panel provided in the stereoscopic display device shown in FIG. 1, which is a cross-sectional view taken along a line III-III in FIG. 2.

FIG. 4 is a plan view showing drive electrodes and auxiliary electrodes formed on one of substrates provided in the switching liquid crystal panel shown in FIG. 2.

FIG. 5 is a plan view showing drive electrodes and auxiliary electrodes formed on the other one of the substrates provided in the switching liquid crystal panel shown in FIG. 2.

FIG. 6 is a cross-sectional view showing a state in which a parallax barrier is realized in the switching liquid crystal panel shown in FIG. 2, which is a cross-sectional view corresponding to the cross section along the line II-II.

FIG. 7 is a cross-sectional view showing a state in which a parallax barrier is realized in the switching liquid crystal panel shown in FIG. 3, which is a cross-sectional view corresponding to the cross section along the line III-III.

FIG. 8 is a cross-sectional view showing the positional relationship between the drive electrodes and the pixels provided in the switching liquid crystal panel shown in FIG. 2.

FIG. 9 is a plan view showing the positional relationship between the drive electrodes and the pixels provided in the switching liquid crystal panel shown in FIG. 2.

FIG. 10 is a graph showing the relationship between brightness and an angle η.

FIG. 11 is an explanatory view showing the relationship between an absorption axis of a polarizing plate positioned on a side of a front surface of the display panel and an alignment axis of an alignment film of a substrate on which electrodes that are to form light shielding parts in the switching liquid crystal panel during the landscape display are provided.

FIG. 12 is an explanatory view showing the relationship between an absorption axis of a polarizing plate positioned on a side of a front surface of the display panel and an alignment axis of an alignment film of a substrate on which electrodes that are to form light shielding parts in the switching liquid crystal panel during the landscape display are provided.

FIG. 13 is a graph showing the relationship between a brightness ratio and an angle n in the case where that the absorption axis of a polarizing plate positioned on a side of a front surface of the display panel and the alignment axis of an alignment film of a substrate on which electrodes that are to form light shielding parts in the switching liquid crystal panel during the landscape display are provided are as shown in FIG. 11.

FIG. 14 is a graph showing the relationship between a brightness ratio and an angle n in the case where that the absorption axis of a polarizing plate positioned on a side of a front surface of the display panel and the alignment axis of an alignment film of a substrate on which electrodes that are to form light shielding parts in the switching liquid crystal panel during the landscape display are provided are as shown in FIG. 12.

FIG. 15 is a graph showing the relationship between a crosstalk ratio and an angle η.

FIG. 16 is a graph showing the relationship between a crosstalk ratio and an angle η in the case where that the absorption axis of a polarizing plate positioned on a side of a front surface of the display panel and the alignment axis of an alignment film of a substrate on which electrodes that are to form light shielding parts in the switching liquid crystal panel during the landscape display are provided are as shown in FIG. 11.

FIG. 17 is a graph showing the relationship between a crosstalk ratio and an angle η in the case where that the absorption axis of a polarizing plate positioned on a side of a front surface of the display panel and the alignment axis of an alignment film of a substrate on which electrodes that are to form light shielding parts in the switching liquid crystal panel during the landscape display are provided are as shown in FIG. 12.

FIG. 18 is a plan view showing an exemplary arrangement of subpixels on a display panel.

FIG. 19 is a plan view showing another exemplary arrangement of subpixels on a display panel.

### DESCRIPTION OF THE INVENTION

A stereoscopic display device according to one embodiment of the present invention includes: a display panel that has a plurality of pixels, and displays a synthetic image in which a right eye image and a left eye image that are divided in a stripe form are arrayed alternately; and a switching liquid crystal panel that is arranged on one side in the thickness direction of the display panel and is capable of realizing a parallax barrier in which transmission parts that transmit light and light shielding parts that block light are arranged alternately. The switching liquid crystal panel includes: a pair of substrates; a liquid crystal layer sealed between the substrates in pair; a plurality of drive electrodes formed on each of the substrates in pair; and a plurality of auxiliary electrodes formed on each of the substrates in pair, the auxiliary electrodes and the drive electrodes being arranged alternately. In the stereoscopic display device, the drive electrodes and the auxiliary electrodes formed on one of the substrates in pair are orthogonal to the drive electrodes and the auxiliary electrodes formed on the other substrate when viewed from the front of the switching liquid crystal panel; a voltage different from a voltage applied to the drive electrodes and the auxiliary electrodes formed on the one substrate is applied to the drive electrodes formed on the other substrate, whereby the light shielding parts are formed; and the transmission parts have an opening width that is equal to or greater than an opening width of the pixels in a direction in which the transmission parts and the light shielding parts are arrayed alternately (the first configuration).

In the first configuration, a left eye image and a right eye image can be separated by light shielding parts, whereby the crosstalk ratio can be prevented from deteriorating, which is different from the liquid crystal lens method.

Further, the light condensing effect can be exhibited within the transmission part by setting the opening width of the transmission parts at a level equal to or greater than the opening width of the pixels in the direction in which the transmission parts and the light shielding parts are arrayed alternately. As a result, the brightness increases.

Still further, since the thickness of the liquid crystal layer that is equal to the thickness in the parallax barrier method allows the light condensing effect to be exhibited, a response speed upon the switching between 2D display and 3D display does not become slower. The first configuration makes it possible to avoid the liquid crystal layer having an increased thickness.

It should be noted that if the opening width of the transmission parts is smaller than the opening width of the pixels, the amount of light that can be condensed is insufficient, whereby a brightness of 50% or more for 2D display cannot be achieved. Therefore, the opening width of the transmission parts may be set greater than the opening width of the pixels, so that the amount of light that can be condensed increases, whereby the intended light condensing effect can be achieved.

Further, since the light condensing effect is not exhibited in a state where no parallax barrier is formed, the switching between 2D display and 3D display is enabled without any decrease in the resolution during 2D display.

The second configuration is the first configuration modified so that the opening width of the transmission parts is equal to an interval of two adjacent ones of the pixels in the direction in which the transmission parts and the light shielding parts are arrayed alternately. In such configuration, the light condensing effect of the transmission parts can be enhanced.

The third configuration is the first or second configuration modified so as to satisfy Formula (1) shown below:

S≦P+(P−A) (1)

where “S” represents the opening width of the transmission parts, “A” represents the opening width of the pixels, and “P” represents the interval of the pixels.

When the opening of the transmission part exceeds the upper limit set according to Formula (1), satisfactory light shielding with respect to light from adjacent pixels cannot be achieved, which results in that the crosstalk ratio deteriorates. However, in the case where the upper limit of the opening of the transmission part is set according to Formula (1), such inconveniences can be avoided, whereby the deterioration of crosstalk can be prevented.

The fourth configuration is any one of the first to third configurations described above modified so as to further include: a polarizing plate arranged between the display panel and the switching liquid crystal panel; and an alignment film formed on one of the substrates in pair, wherein the absorption axis of the polarizing plate is parallel to the alignment axis of the alignment film. In such a configuration, for example, in the case where subpixels are arrayed in the lengthwise direction of the drive electrodes formed on the substrate having the alignment film, it is possible to achieve the light condensing effect in the state where light shielding parts are formed at positions corresponding to the drive electrodes formed on the substrate having the alignment film, while suppressing the light condensing effect in the state where the light shielding parts are formed at positions corresponding to the drive electrodes formed on the other substrate.

The fifth configuration is the fourth configuration described above modified so that the display area of the display panel is landscape oriented, in a state in which the light shielding parts are formed at positions corresponding to the drive electrodes formed on the substrate having the alignment film formed thereon, among the substrates in pair. In such a configuration, it is possible to achieve the light condensing effect in the so-called landscape display, while suppressing the light condensing effect in the so-called portrait display.

The sixth configuration is the fourth configuration described above modified so that the display area of the display panel is portrait oriented, in a state in which the light shielding parts are formed at positions corresponding to the drive electrodes formed on the substrate having the alignment film formed thereon, among the substrates in pair. In such a configuration, it is possible to achieve the light condensing effect in the so-called portrait display, while suppressing the light condensing effect in the so-called landscape display.

The seventh configuration is any one of the fourth to sixth configurations described above modified so that the liquid crystal layer has a retardation set at a first minimum. In such a configuration, liquid crystal molecules are more responsive in portions in the liquid crystal layer corresponding to areas (inter-line areas) between the drive electrodes and the auxiliary electrodes formed on one of the substrates in pair. As a result, light leakage through the light shielding parts can be reduced.

The eighth configuration is the seventh configuration described above modified so that the liquid crystal layer has a dielectric anisotropy of 4 or greater. In such a configuration, liquid crystal molecules become further more responsive in portions in the liquid crystal layer corresponding to areas (inter-line areas) between the drive electrodes and the auxiliary electrodes formed on one of the substrates in pair. As a result, light leakage through the light shielding parts can be reduced further.

Hereinafter, more specific embodiments of the present invention are explained with reference to the drawings. It should be noted that, for convenience of explanation, each drawing referred to hereinafter shows only principal members necessary for explanation of the present invention, in a simplified state, among the constituent members of the embodiments of the present invention. Therefore, the stereoscopic display device according to the present invention may include arbitrary constituent members that are not shown in the drawings referred to in the present specification. Further, the dimensions of the members shown in the drawings do not faithfully reflect actual dimensions of the constituent members, dimensional ratios of the constituent members, etc.

### Embodiment

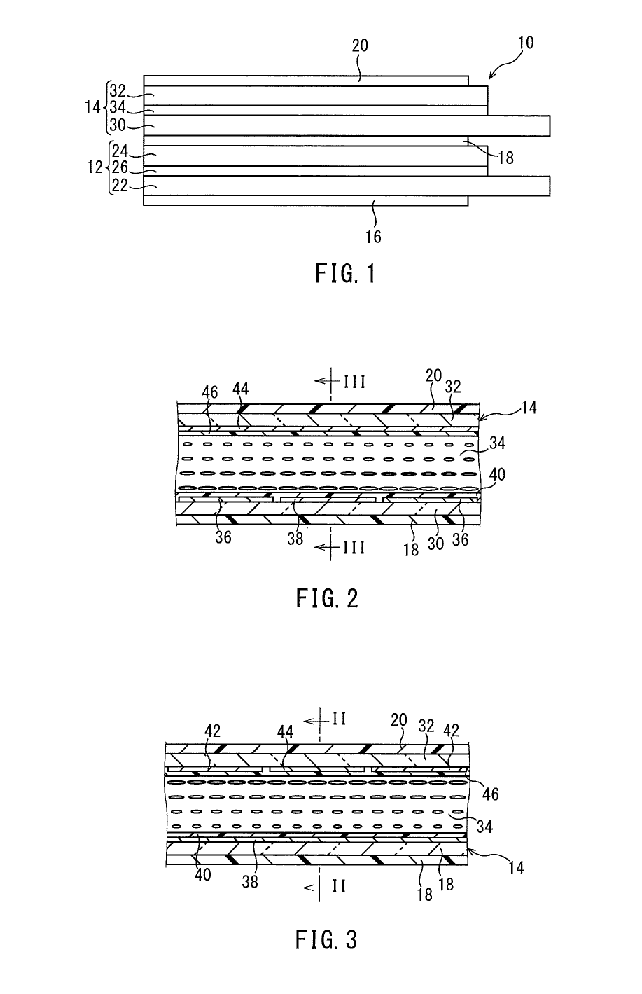

FIG. 1 shows a stereoscopic display device 10 as Embodiment 1 of the present invention. The stereoscopic display device 10 includes a display panel 12, a switching liquid crystal panel 14, and polarizing plates 16, 18, and 20.

The display panel 12 is a liquid crystal panel. The display panel 12 includes an active matrix substrate 22, a counter substrate 24, and a liquid crystal layer 26 sealed between these substrates 22 and 24. In the display panel 12, the liquid crystal is in an arbitrary operation mode.

The display panel 12 includes a plurality of pixels 28 (see FIG. 8). The plurality of pixels 28 are formed, for example, in matrix form. The area where the plurality of pixels 28 are formed is a display area of the display panel 12.

In the display panel 12, as shown in FIG. 8, which will be described later, rows of pixels 28 that display an image viewed by the right eye of a viewer (a right eye image), and rows of pixels 28 that display an image viewed by the left eye of the viewer (a left eye image) are alternately arranged in the lateral direction of the display panel 12. In other words, a right eye image and a left eye image are divided into pixel rows (into a stripe form). A synthetic image obtained by alternately arraying the portions of the right eye image and the portions of the left eye image thus obtained by dividing into a stripe form each is displayed in the display area of the display panel 12.

On the display panel 12, on one side thereof in the thickness direction, a switching liquid crystal panel 14 is arranged. As shown in FIGS. 2 and 3, the switching liquid crystal panel 14 includes a pair of substrates 30, 32 and a liquid crystal layer 34.

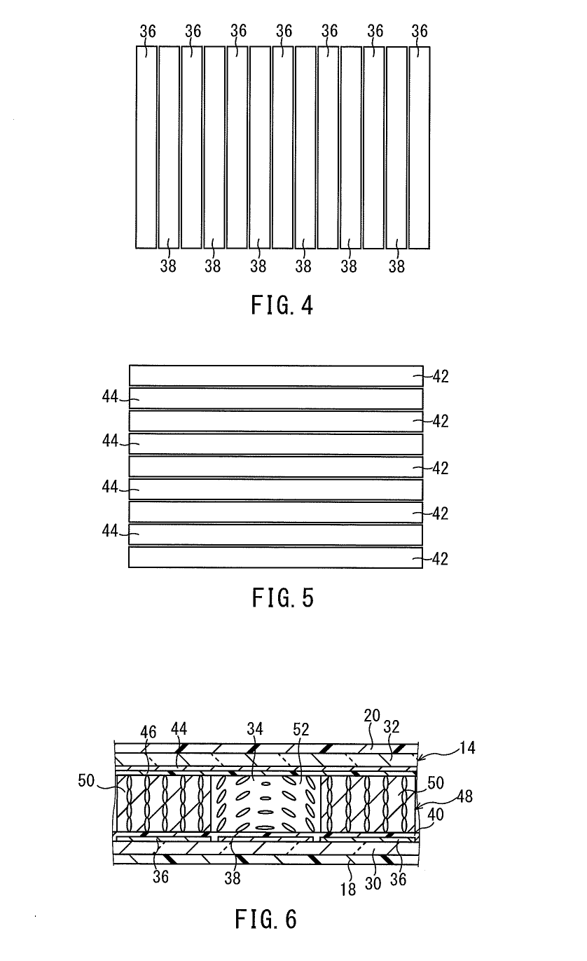

The substrate 30, one of the pair, is, for example, a low-alkali glass substrate. On the substrate 30, drive electrodes 36 and auxiliary electrodes 38 are arrayed alternately, as shown in FIG. 4. Each of the electrodes 36 and 38 is, for example, a transparent conductive film such as an indium tin oxide film (ITO film).

The drive electrodes 36 and the auxiliary electrodes 38 extend in the longitudinal direction of the substrate 30 (in the longitudinal direction of the display area of the display panel 12), in an approximately uniform width each. In other words, the drive electrodes 36 and the auxiliary electrodes 38 are arrayed alternately in the lateral direction of the substrate 30 (in the lateral direction of the display area of the display panel 12). It should be noted that the longitudinal direction and the lateral direction of the display area of the display panel 12 in this case refers to the vertical direction and the horizontal direction, respectively, of the display area in the landscape display (the length in the horizontal direction is greater than the length in the vertical direction).

The drive electrodes 36 and the auxiliary electrodes 38 are covered with an alignment film 40. The alignment film 40 is, for example, a polyimide resin film.

The other substrate 32 is, for example, a low-alkali glass substrate. On the substrate 32, drive electrodes 42 and auxiliary electrodes 44 are arrayed alternately, as shown in FIG. 5. Each of the electrodes 42 and 44 is, for example, a transparent conductive film such as an indium tin oxide film (ITO film).

The drive electrodes 42 and the auxiliary electrodes 44 extend in the lateral direction of the substrate 32 (in the longitudinal direction of the display area of the display panel 12), in an approximately uniform width each. In other words, the drive electrodes 42 and the auxiliary electrodes 44 are arrayed alternately in the longitudinal direction of the substrate 32 (in the lateral direction of the display area of the display panel 12). It should be noted that the longitudinal direction and the lateral direction of the display area of the display panel 12 in this case refers to the vertical direction and the horizontal direction, respectively, of the display area in the portrait display (the length in the vertical direction is greater than the length in the horizontal direction).

The drive electrodes 42 and the auxiliary electrodes 44 are covered with an alignment film 46. The alignment film 46 is, for example, a polyimide resin film.

The liquid crystal layer 34 is sealed between the pair of substrates 30 and 32. In the switching liquid crystal panel 14, the operation mode of the liquid crystal is the TN mode.

The retardation (Δn·d) of the liquid crystal layer 34 is set at, for example, a first minimum. Here, “Δn” represents a refractive index anisotropy, which is indicative of a difference between a refractive index along the long axis of the liquid crystal molecule and a refractive index along the short axis thereof. Further, “d” represents a thickness of the liquid crystal layer 34, which is indicative of a cell gap.

The dielectric anisotropy Δε of the liquid crystal layer 34 is set at, for example, 4 or greater. Here, “Δε” represents a difference between a dielectric constant along the long axis of the liquid crystal molecule and a dielectric constant along the short axis thereof.

In the stereoscopic display device 10, a parallax barrier is realized in the switching liquid crystal panel 14. The following explains the parallax barrier 48 while referring to FIG. 6. In order to realize the parallax barrier 48, the auxiliary electrodes 38, the drive electrodes 42, and the auxiliary electrodes 44 (see FIG. 5) are caused to have the same potential (for example, 0 V), and the drive electrodes 36 are caused to have a different potential from that of these electrodes 38, 42, and 44 (for example, 5 V). This causes the orientations of the liquid crystal molecules present between the drive electrodes 36 and the counter electrode (the drive electrodes 42 and the auxiliary electrodes 44) to change. In the liquid crystal layer 34, therefore, parts that are positioned between the drive electrodes 36 and the counter electrode (the drive electrodes 42 and the auxiliary electrodes 44) function as light shielding parts 50, and each part positioned between adjacent two of the light shielding parts 50 functions as a transmission part 52. As a result, the parallax barrier 48 is realized in which the light shielding parts 50 and the transmission parts 52 are arrayed alternately. The direction in which the light shielding parts 50 and the transmission parts 52 are arrayed alternately is the horizontal direction of the display area of the display panel 12 in the landscape display.

The method of applying voltages to the electrodes 36, 38, 42, and 44, respectively, in order to realize the parallax barrier 48 in the switching liquid crystal panel 14 may be, for example, a method in which a voltage applied to the drive electrodes 36 and a voltage applied to the other electrodes 38, 42, and 44 have opposite phases to each other, or a method in which a voltage is applied to the drive electrodes 36 while the other electrodes 38, 42, and 44 are grounded. The voltage to be applied is, for example, a voltage of 5 V in a rectangular waveform.

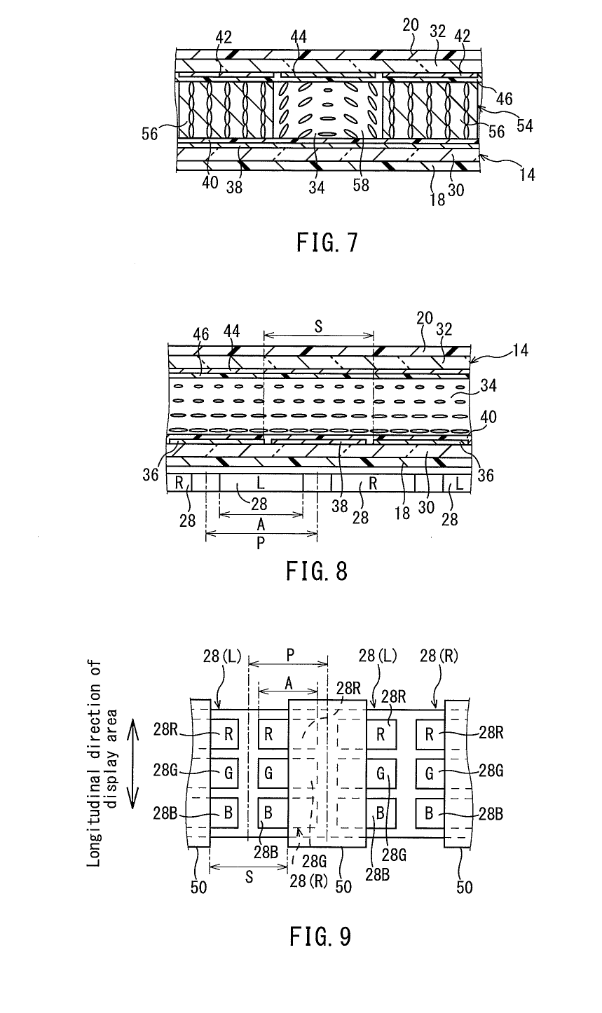

Alternatively, in the stereoscopic display device 10, a parallax barrier 54 may be realized in the switching liquid crystal panel 14, other than the parallax barrier 48. The following explains the parallax barrier 54 while referring to FIG. 7. In order to realize the parallax barrier 54, the drive electrodes 36 (see FIG. 4), the auxiliary electrodes 38, and the auxiliary electrodes 44 are caused to have the same potential (for example, 0 V), and the drive electrodes 42 are caused to have a different potential from that of these electrodes 36, 38, and 44 (for example, 5 V). This causes the orientations of the liquid crystal molecules present between the drive electrodes 42 and the counter electrode (the drive electrodes 36 and the auxiliary electrodes 38) to change.

In the liquid crystal layer 34, therefore, parts that are positioned between the drive electrodes 42 and the counter electrode (the drive electrodes 36 and the auxiliary electrodes 38) function as light shielding parts 56, and each part positioned between adjacent two of the light shielding parts 56 functions as a transmission part 58. As a result, the parallax barrier 54 is realized in which the light shielding parts 56 and the transmission parts 58 are arrayed alternately. The direction in which the light shielding parts 56 and the transmission parts 58 are arrayed alternately is the vertical direction of the display area of the display panel 12 in the portrait display.

The method of applying voltages to the electrodes 36, 38, 42, and 44, respectively, in order to realize the parallax barrier 54 in the switching liquid crystal panel 14 may be, for example, a method in which a voltage applied to the drive electrodes 42 and a voltage applied to the other electrodes 36, 38, and 44 have opposite phases to each other, or a method in which a voltage is applied to the drive electrodes 42 while the other electrodes 36, 38, and 44 are grounded. The voltage to be applied is, for example, a voltage of 5 V in a rectangular waveform.

In the stereoscopic display device 10, a synthetic image obtained by alternately arraying the portions of the right eye image and the portions of the left eye image obtained by dividing into a stripe form each is displayed in the display area of the display panel 12, in a state in which the parallax barrier is realized in the switching liquid crystal panel 14. This allows only the right eye image to reach the right eye of a viewer, and allows only the left eye image to reach the left eye of the viewer. As a result, the viewer can view a stereoscopic image without using special glasses.

In the stereoscopic display device 10, a planar image may be displayed on the display panel 12 in a state in which the parallax barrier is not realized in the switching liquid crystal panel 14, so that the planar image can be shown to the viewer.

In the switching liquid crystal panel 14, an opening width S of the transmission parts 52 shown in FIG. 8 (the dimension thereof in the direction in which the transmission parts 52 and the light shielding parts 50 are arrayed alternately) satisfies Formula (1) shown below:

A≦S≦P+(P−A) (1)

It should be noted that in Formula (1), “A” represents an opening width of the pixels 28 (the dimension thereof in the direction in which the transmission parts 52 and the light shielding parts 50 are arrayed alternately), and “P” represents an interval of adjacent two of the pixels 28 that are adjacent in the direction in which the transmission parts 52 and the light shielding parts 50 are arrayed alternately (pixel pitch) (see FIG. 8).

Each pixel 28 may include a plurality of subpixels 28R, 28G, and 28B, as shown in FIG. 9. In the example shown in FIG. 9, the plurality of subpixels 28R, 28G, and 28B are arrayed in the vertical direction of the display area of the display panel 12 in the landscape display. In the case where each pixel 28 includes a plurality of subpixels 28R, 28G, and 28B, the opening width A of the pixels 28 shown in FIG. 8 is the opening width of the subpixels 28R, 28G, and 28B (the dimension thereof in the direction in which the transmission parts 52 and the light shielding parts 50 are arrayed alternately), as shown in FIG. 9.

If the opening width S of the transmission parts 52 is at or above the lower limit value indicated by Formula (1) (the opening width A of the pixels 28, i.e., the opening width A of the subpixels 28R, 28G, and 28B), pseudo lenses are formed in the transmission parts 52, as shown in FIG. 6. This allows the transmission parts 52 to exhibit the light condensing effect. As a result, the brightness increases.

If the opening width S of the transmission parts 52 exceeds the upper limit value indicated by Formula (1) (a value obtained by adding the pixel pitch P and a value obtained by subtracting the opening width A of the pixels 28 from this pixel pitch P), the transmission parts 52 hardly exhibit the light condensing effect.

If the opening width S of the transmission parts 52 exceeds the upper limit value indicated by Formula (1), light from the adjacent pixels 28 cannot be blocked sufficiently. This leads to the deterioration of the crosstalk ratio. Therefore, by setting the opening width S of the transmission parts 52 at or below the upper limit value indicated by Formula (1), the deterioration of the crosstalk ratio can be prevented.

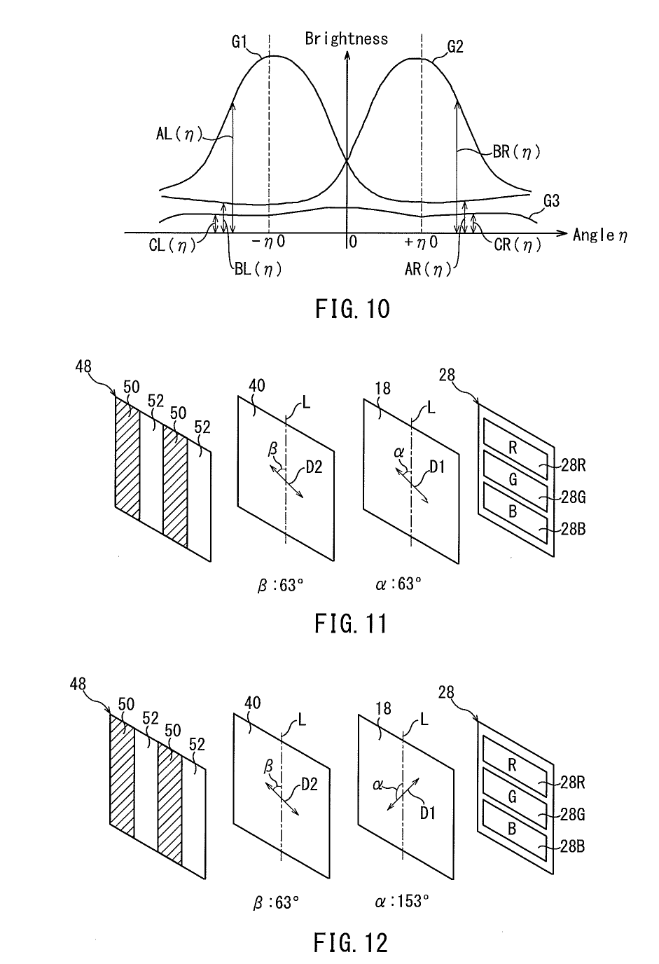

With regard to the stereoscopic display device 10 of the present embodiment, an experiment (Experiment 1) was carried out to examine the relationship between the angle at which a synthetic image displayed on the display panel 12 is viewed and the brightness ratio. Here, the brightness ratio is, for example, a ratio between a brightness when the parallax barrier 48 is realized in the switching liquid crystal panel 14 (brightness during 3D display) and a brightness when the parallax barrier 48 is not realized in the switching liquid crystal panel 14 (brightness during 2D display). The brightness during 3D display is a brightness in the case where a left eye image is displayed in black and a right eye image is displayed in white in a state in which the parallax barrier 48 is realized in the switching liquid crystal panel 14. The brightness during 2D display is a brightness in the case where white display is provided in the display area of the display panel 12 in a state in which the parallax barrier 48 is not realized in the switching liquid crystal panel 14. The brightness ratio is explained further in more detail below, with reference to FIG. 10. FIG. 10 shows a graph that shows the relationship between an angle η and brightness. The angle η is, for example, an angle of inclination to left or right with respect to a position of viewing the display panel 12 straightly in front of the same. In FIG. 10, the graph G1 shows the relationship between the brightness and the angle η in a state in which a right eye image is displayed in black and a left eye image is displayed in white. The graph G2 shows the relationship between the brightness and the angle η in a state in which a right eye image is displayed in white and a left eye image is displayed in black. The graph G3 shows the relationship between the brightness and the angle η in a state in which a right eye image and a left eye image are displayed in black. There is a position (eye point) optimal for viewing a stereoscopic display. The eye point of the left eye is at such a position that the brightness is maximized in the graph G1, and the angle herein is −η0. The eye point of the right eye is at such a position that the brightness is maximized in the graph G2, and the angle herein is +η0. Hereinafter, the “brightness ratio” refers to a brightness ratio at the eye point.

In Experiment 1, an array pitch of the transmission parts 52 was 154.285 μm. Experiment 1 was performed with regard to the cases where the opening width S of the transmission parts 46 was 55 μm, 66 μm, 77 μm, 88 μm, and 98 μm, respectively. The liquid crystal layer 34 had a thickness of 6.5 μm. The pixel pitch P was 77.25 μm. The opening width A of the pixels 28 was 54.25 μm. The liquid crystal had a Δn of 0.078. It should be noted that the Δn of the liquid crystal was set at a first minimum in the case where the liquid crystal layer 34 had a thickness of 6.5 μm.

Experiment 1 was carried out with regard to a case where the absorption axis D1 of the polarizing plate 18 arranged between the display panel 12 and the switching liquid crystal panel 14 and the alignment axis D2 of the alignment film 40 are parallel with each other, as shown in FIG. 11 (Example). In Example, an angle a formed by the absorption axis D1 with respect to the reference line L that extends in the longitudinal direction of the display area of display panel 12 (the vertical direction in the landscape display) was 63°.

Experiment 1 was carried out with regard to a case where the absorption axis D1 of the polarizing plate 18 and the alignment axis D2 of the alignment film 40 are orthogonal to each other, as shown in FIG. 12 (Comparative Example). In Comparative Example, an angle a formed by the absorption axis D1 with respect to the reference line L was 153°.

In Experiment 1, the range of the opening width S of the transmission parts 52 set according to Formula (1) is as follows:

54.25≦S≦100.25

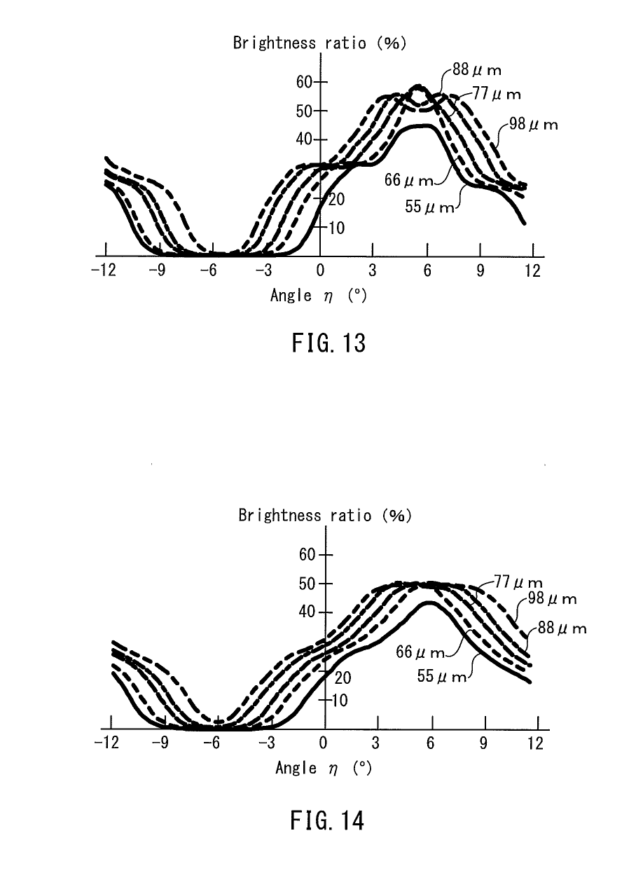

The results of Experiment 1 are shown in FIGS. 13, 14, and Table 1. Here, Table 1 shows brightness ratios at the eye point. In Experiment 1, the eye point was at a position of approximately ±5.5°.

TABLE 1

| | | | | | |
|---|---|---|---|---|---|
| Opening width of | 55 | 66 | 77 | 88 | 98 |
| transmission parts (μm) | | | | | |
| Brightness ratio of | 45 | 58 | 59 | 52 | 51 |
| Example (%) | | | | | |
| Brightness ratio of | 44 | 50 | 50 | 50 | 50 |
| Comparative Example (%) | | | | | |

As is clear from FIGS. 13, 14, and Table 1, in Experiment 1, the light condensing effect was exhibited and a brightness ratio of 50% or more was obtained in Example, whereas in Comparative Example, even if the opening width S was increased, a brightness ratio of up to only 50% was obtained, which means that the light condensing effect was not achieved.

With regard to the stereoscopic display device 10 of the present embodiment, an experiment (Experiment 2) was carried out to examine the relationship between the angle at which a synthetic image displayed on the display panel 12 is viewed and the crosstalk ratio. Here, the crosstalk ratio indicates to what extent the level of black display increases with respect to background components (both are displayer in black), for example, when either the pixels 28 for the left eye image or the pixels 28 for the right eye image are caused to perform white display and the others are caused to perform black display in a state where the parallax barrier 48 is realized in the switching liquid crystal panel 14. This is an index that indicates to what extent either the right eye image or the left eye image is viewed on the other. Here, the crosstalk ratio is defined according to Formulae (2) and (3) shown below:

LXT={(BL(η)−CL(η))/(AL(η)−CL(η))}*100 (2)

RXT={(AR(η)−CR(η))/(BR(η)−CR(η))}*100 (3)

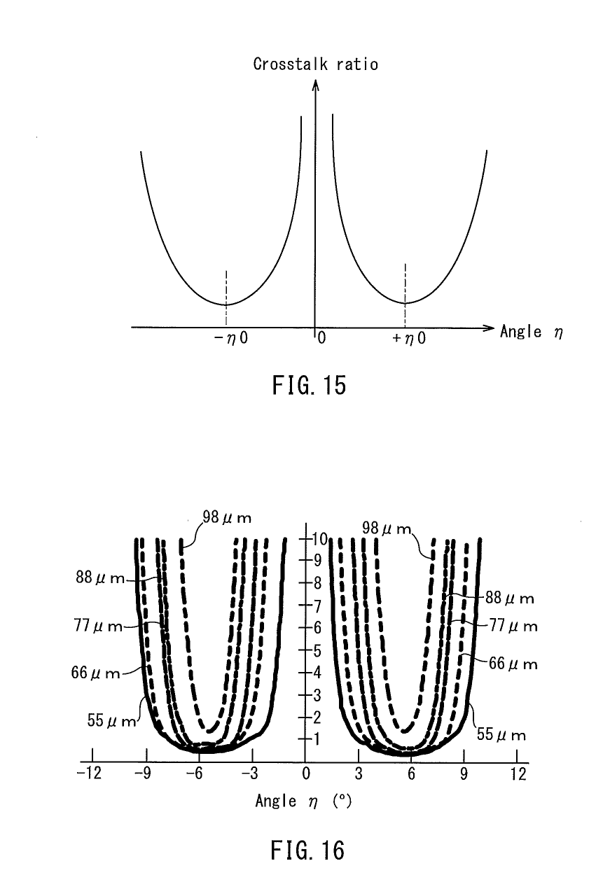

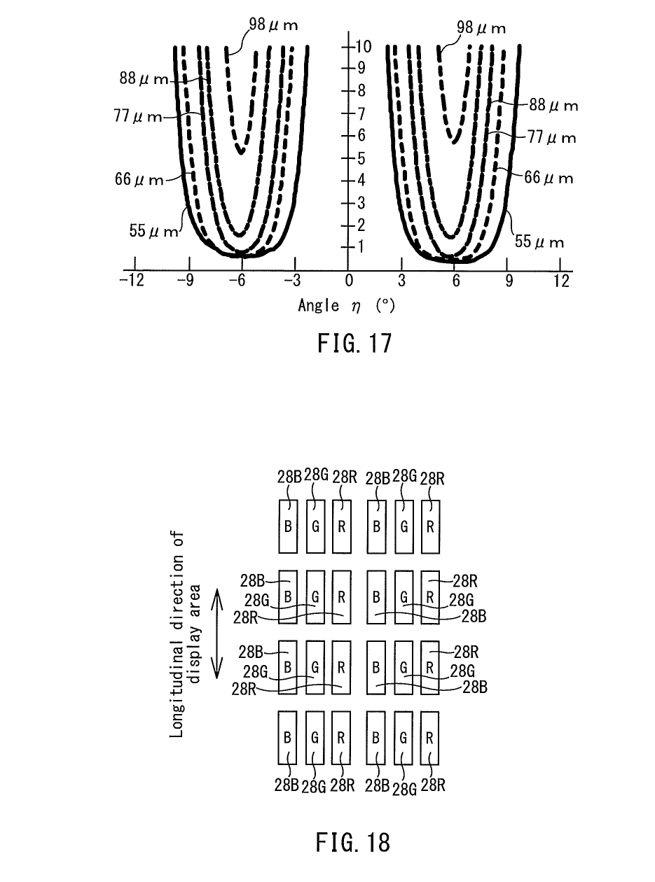

In the formulae, “LXT” represents a crosstalk ratio for the left eye; “RXT” represents a crosstalk ratio for the right eye; and “η” represents the above-described angle η. As shown in FIG. 10, “ΔL(η)” represents a brightness of an image viewed by the left eye in the graph G1, “AR(η)” represents a brightness of an image viewed by the right eye in the graph G1, “BL(η)” represents a brightness of an image viewed by the left eye in the graph G2, “BR(η)” represents a brightness of an image viewed by the right eye in the graph G2, “CL(η)” represents a brightness of an image viewed by the left eye in the graph G3, and “CR(η)” represents a brightness of an image viewed by the right eye in the graph G3. The crosstalk ratio determined by Formulae (2) and (3) described above becomes minimum at the eye points (angle η=+η0 and η=−η(0), as shown in FIG. 15. Hereinafter, the crosstalk ratio refers to a crosstalk ratio at the eye points. Generally, as the crosstalk ratio is lower, more excellent 3D display can be obtained, and influences to human bodies can be reduced. The experiment conditions of Experiment 2 are the same as those of Experiment 1. The results of Experiment 2 are shown in FIGS. 16, 17, and Table 2.

TABLE 2

| | | | | | |
|---|---|---|---|---|---|
| Opening width of transmission | 55 | 66 | 77 | 88 | 98 |
| parts (μm) | | | | | |
| Crosstalk ratio of Example (%) | 0.4 | 0.4 | 0.4 | 0.6 | 1.4 |
| Crosstalk ratio of Comparative | 0.4 | 0.4 | 0.7 | 1.5 | 5.7 |
| Example (%) | | | | | |

As is clear from FIGS. 16, 17 and Table 2, in Experiment 2, in Example, it is possible to suppress an increase in the crosstalk ratio, even in the case where the opening width S of the transmission parts 52 is increased as compared with Comparative Example.

The configuration of Example makes it possible to achieve both of the enhancement of the brightness ratio and a low crosstalk ratio at the same time in the landscape display. On the other hand, in the configuration of Comparative Example, the light condensing effect is exhibited in the portrait display, though the light condensing effect cannot be exhibited in the landscape display. In the case where the subpixels 28R, 28G, and 28B, which emit the same color, respectively, are arrayed in the vertical direction of the display area of the display panel 12 in the portrait display as shown in FIG. 18, when the light condensing effect is exhibited in the portrait display, color cracks occur. Therefore, in the case where the array of subpixels 28R, 28G, and 28B as shown in FIG. 18 is used, the configuration of Example is essential.

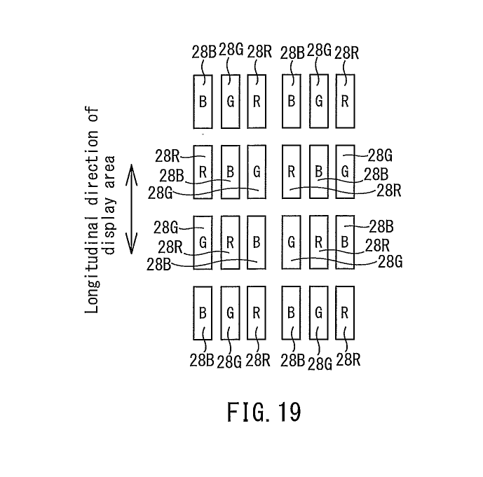

It should be noted that, in the case where the subpixels 28R, 28G, and 28B are arrayed in a predetermined order in each of the vertical direction and the horizontal direction of the display area of the display panel 12 in the portrait display as shown in FIG. 19, the occurrence of color cracks can be avoided, even if the light condensing effect is exhibited in the portrait display.

So far embodiments of the present invention have been described in detail, but they are merely examples and do not limit the present invention at all.

For example, in the foregoing embodiments, the display panel 12 may be a plasma display panel, an organic EL (Electro Luminescence) panel, an inorganic EL panel, or the like.

1. A stereoscopic display device comprising:
a display panel that has a plurality of pixels, and displays a synthetic image in which a right eye image and a left eye image that are divided in a stripe form are arrayed alternately; and
a switching liquid crystal panel that is arranged on one side in the thickness direction of the display panel and is capable of realizing a parallax barrier in which transmission parts that transmit light and light shielding parts that block light are arranged alternately,
wherein the switching liquid crystal panel includes:
a pair of substrates;
a liquid crystal layer sealed between the substrates in pair;
a plurality of drive electrodes formed on each of the substrates in pair; and
a plurality of auxiliary electrodes formed on each of the substrates in pair, the auxiliary electrodes and the drive electrodes being arranged alternately,
wherein the drive electrodes and the auxiliary electrodes formed on one of the substrates in pair are orthogonal to the drive electrodes and the auxiliary electrodes formed on the other substrate when viewed from the front of the switching liquid crystal panel,
a voltage different from a voltage applied to the drive electrodes and the auxiliary electrodes formed on the one substrate is applied to the drive electrodes formed on the other substrate, whereby the light shielding parts are formed, and
the transmission parts have an opening width that is equal to or greater than an opening width of the pixels in a direction in which the transmission parts and the light shielding parts are arrayed alternately.

2. The stereoscopic display device according to claim 1, wherein the opening width of the transmission parts is equal to an interval of two adjacent ones of the pixels in the direction in which the transmission parts and the light shielding parts are arrayed alternately.

3. The stereoscopic display device according to claim 1, satisfying Formula (1) shown below:
S≦P+(P−A) (1)
where “S” represents the opening width of the transmission parts, “A” represents the opening width of the pixels, and “P” represents the interval of the pixels.

4. The stereoscopic display device according to claim 1, further comprising:
a polarizing plate arranged between the display panel and the switching liquid crystal panel; and
an alignment film formed on one of the substrates in pair,
wherein the absorption axis of the polarizing plate is parallel to the alignment axis of the alignment film.

5. The stereoscopic display device according to claim 4,
wherein the display area of the display panel is landscape oriented, in a state in which the light shielding parts are formed at positions corresponding to the drive electrodes formed on the substrate having the alignment film formed thereon, among the substrates in pair.

6. The stereoscopic display device according to claim 4,
wherein the display area of the display panel is portrait oriented, in a state in which the light shielding parts are formed at positions corresponding to the drive electrodes formed on the substrate having the alignment film formed thereon, among the substrates in pair.

7. The stereoscopic display device according to claim 4, wherein the liquid crystal layer has a retardation set at a first minimum.

8. The stereoscopic display device according to claim 7, wherein the liquid crystal layer has a dielectric anisotropy of 4 or greater.
